(19) United States
(12) Patent Application Publication
(10) Pub. No.: US 2010/0129641 A1
(43) Pub. Date: May 27, 2010

(54) POLYMER CARBON COMPOSITES

(76) Inventors: Leonardo C. Lopez, Midland, MI (US); Scott T. Matteucci, Midland, MI (US); Sarada P. Namhata, Midland, MI (US); Michael S. Paquette, Midland, MI (US)

Correspondence Address: The Dow Chemical Company, Intellectual Property Section, P.O. Box 1967, Midland, MI, 48641-1967, US

(21) Appl. No.: 12/623,320

(22) Filed: Nov. 20, 2009

Related U.S. Application Data
(60) Provisional application No. 61/117,805, filed on Nov. 25, 2008.

(51) Int. Cl. C08K 3/04; B32B 5/16

(52) U.S. Cl. 428/323; 524/496

(57) ABSTRACT

The instant invention generally provides polymer carbon composite comprising a molecularly self-assembling material and a carbon filler, and a process of making and an article comprising the polymer carbon composite.

### CROSS-REFERENCE TO RELATED APPLICATION(S)

This application claims benefit of priority from U.S. Provisional Patent Application No. 61/117,805, filed Nov. 25, 2008, which application is incorporated by reference herein in its entirety.

The present invention is in the field of polymer carbon composites and related processes of making and articles comprising the polymer carbon composites.

### BACKGROUND OF THE INVENTION

Graphene is a single aromatic sheet of sp²-bonded carbon atoms that is the single sheet, “2-dimensional” (1-carbon atom thick) counterpart of naturally occurring, “3-dimensional” graphite, which comprises a stack of a plurality of graphene sheets (Niyogi et al., “Solution Properties of Graphite and Graphene, Journal of the American Chemical Society, 2006; 128(24): 7720-7721). Mack et al., “Graphite Nanoplatelet Reinforcement of Electrospun Polyacrylonitrile Nanofibers,” Advanced Materials, 2005; 17(1):77-80, mention that graphene has a Brunauer-Emmett-Teller (BET) theoretical surface area of about 2630 square meters per gram (m²/g). Exfoliated graphites have a BET surface area greater than BET surface area of natural (i.e., unexfoliated) graphite but less than the BET theoretical surface area of graphene. Conventional exfoliated graphite typically has a BET surface area of up to about 110 m²/g. Highly exfoliated graphites having a BET surface area of less than that of the BET theoretical surface area of graphene are sometimes referred to as graphene in the art.

U.S. Patent Application Publication Number (USPAPN) US 2007/0158618 A1 mentions a nanocomposite material comprising fully separated nano-scaled graphene platelets dispersed in a matrix material, wherein each of the platelets comprises a single sheet of graphite plane (i.e., graphene per se) or multiple sheets of graphite plane and has a thickness no greater than 100 nanometers (nm) and the platelets have an average length, width, or diameter no greater than 500 nm and the graphene plates are present in an amount not less than 15 percent (%) by weight based on the total weight of the platelets and the matrix material combined.

PCT International Patent Application Publication Number (PCT IPAPN) WO 2008/079585 and USPAPNs US 2008-0171824 and US 2008-0039573 mention highly exfoliated graphite and certain polymers filled with or containing same.

There is a need in the polymer art for new polymer carbon composites, and processes of making and articles comprising the polymer carbon composites.

### SUMMARY OF THE INVENTION

In a first embodiment, the instant invention is a polymer carbon composite comprising a molecularly self-assembling (MSA) material and a carbon filler dispersed in the MSA material, wherein the carbon filler is in the form of a particle having an average size of 30 micrometers (μm) or smaller, wherein the carbon filler comprises a graphite or expanded graphite, the carbon filler comprising from 1 weight percent (wt %) to 90 wt % of the polymer carbon composite based on total weight of the polymer carbon composite. Preferably, the carbon filler comprises an expanded graphite, more preferably an ultra-high surface area (UHSA) expanded graphite.

In a second embodiment, the instant invention is a process for making the polymer carbon composite of the first embodiment, the process comprising the step of: mixing a desired amount of the carbon filler in either a melt comprising the MSA material or a solution comprising a solvent and the MSA material to produce the polymer carbon composite of the first embodiment. Preferably the process employs the melt comprising the MSA material.

In a third embodiment, the instant invention is an article comprising the polymer carbon composite of the first embodiment. Preferably, the article comprises a molded part (e.g., suitable for electropainting), coating, laminate, or electronic component. Preferably, the polymer carbon composite of the first embodiment is electropainted, extruded, molded, blow molded, or cast to form the article.

In some embodiments, the polymer carbon composite of the first embodiment is melt processable even at high filler concentrations (e.g., greater than or equal to 50 wt % filler). Preferably, the polymer carbon composite of the first embodiment is characterized by at least one improved electroconductive property (e.g., increased conduction of electrical current, dielectric constant (i.e., relative static permittivity), and loss factor) compared to that of the corresponding unfilled MSA and, consequently, is useful in, for example, at least one of electropainting, charge dissipation (i.e., anti-static), electricity transmission, and electromagnetic shielding applications.

Additional embodiments of the present invention are illustrated in the accompanying drawings and are described in the following detailed description and claims.

### BRIEF DESCRIPTION OF THE DRAWINGS

FIG. 1 graphically depicts thermogravimetric analysis (TGA) for the MSA material of Comparative Example 1 and graphite composites of Examples 1A to 1C.

FIG. 2 graphically depicts melt viscosity results for the MSA material of Comparative Example 1 and the graphite composite of Example 1C and the UHSA exfoliated graphite composite of Example 2C.

FIG. 3 is a graphical plot of relative static permittivities (i.e., dielectric constants) and loss factors for the MSA material of Comparative Example 1 and the graphite composites of Examples 1A to 1C.

FIG. 4 shows a transmission electron microscope (TEM) image at 3000 times magnification of the graphite composite of Example 1B.

FIG. 5 shows X-ray diffraction (XRD) results for the MSA material of Comparative Example 1, the graphite PEA-C2C50% composites of Examples 1A to 1C, and the UHSA exfoliated graphite PEA-C2C50% composites of Examples 2A to 2C.

FIG. 6 shows conductivity testing results for the MSA material of Comparative Example 1, the graphite PEA-C2C50% composites of Examples 1A to 1C, and the UHSA exfoliated graphite PEA-C2C50% composites of Examples 2A to 2C.

FIG. 7 graphically depicts TGA results for the MSA material of Comparative Example 1 and the UHSA exfoliated graphite composites of Examples 2A and 2C.

FIG. 8 is a graphical plot of relative static permittivities and loss factors for the MSA material of Comparative Example 1 and the UHSA exfoliated graphite composites of Examples 2A to 2C.

FIG. 9 shows a TEM image at 3000 times magnification of the UHSA exfoliated graphite composite of Example 2C.

### DETAILED DESCRIPTION OF THE INVENTION

As used herein, “a,” “an,” “the,” “at least one,” and “one or more” are used interchangeably. In any embodiment of the instant invention described herein, the open-ended terms “comprising,” “comprises,” and the like (which are synonymous with “including,” “having,” and “characterized by”) may be replaced by the respective partially closed phrases “consisting essentially of,” consists essentially of,” and the like or the respective closed phrases “consisting of,” “consists of,” and the like. In the present application, when referring to a preceding list of elements (e.g., ingredients), the phrases “mixture thereof,” “combination thereof,” and the like mean any two or more, including all, of the listed elements.

For purposes of United States patent practice and other patent practices allowing incorporation of subject matter by reference, the entire contents—unless otherwise indicated—of each U.S. patent, U.S. patent application, U.S. patent application publication, PCT international patent application and WO publication equivalent thereof, referenced in the instant Detailed Description of the Invention are hereby incorporated by reference. In an event where there is a conflict between what is written in the present specification and what is written in a patent, patent application, or patent application publication, or a portion thereof that is incorporated by reference, what is written in the present specification controls. The present specification may be subsequently amended to incorporate by reference subject matter from a U.S. patent or U.S. patent application publication, or portion thereof, instead of from a PCT international patent application or WO publication equivalent, or portion thereof, originally referenced herein, provided that no new matter is added and the U.S. patent or U.S. patent application publication claims priority directly from the PCT international patent application.

In the present application, headings (e.g., “Definitions”) are used for convenience and are not meant, and should not be used, to limit scope of the present disclosure in any way.

In the present application, any lower limit of a range of numbers, or any preferred lower limit of the range, may be combined with any upper limit of the range, or any preferred upper limit of the range, to define a preferred embodiment of the range. Each range of numbers includes all numbers subsumed within that range (e.g., the range from about 1 to about 5 includes, for example, 1, 1.5, 2, 2.75, 3, 3.80, 4, and 5).

In an event where there is a conflict between a unit value that is recited without parentheses, e.g., 2 inches, and a corresponding unit value that is parenthetically recited, e.g., (5 centimeters), the unit value recited without parentheses controls.

### DEFINITIONS

As used herein, the term “desired amount” means a weight sufficient for producing an intended composite.

The term “dispersed” means distributed substantially evenly throughout a medium (e.g., a polymer).

The term “fiber” means a fibril-, filament-, strand-, or thread-like structure. Preferably, the fiber has an aspect ratio of 10:1 or higher, preferably 100:1 or higher. In some embodiments, the fiber is continuous. In other embodiments, the fiber is discontinuous.

BET surface area is determined on a Quantachrome Model Autosorb-1 nitrogen adsorption analyzer by measuring the volume of gaseous nitrogen adsorbed at 77 degrees Kelvin (° K.) by a sample at a given nitrogen partial pressure and by conducting the appropriate calculations according to the BET model. Thus, the BET surface area is determined by the nitrogen adsorption method in which dried and degassed samples are analyzed on an automatic volumetric sorption analyzer, Quantachrome Model Autosorb-1 nitrogen adsorption analyzer. The instrument works on the principle of measuring the volume of gaseous nitrogen adsorbed by a sample at a given nitrogen partial pressure. The volumes of gas adsorbed at various pressures are used in the BET model for the calculation of the BET surface area of the sample.

The term “loss factor” means the product of a dissipation factor and dielectric constant of a material.

Particle size analysis methods and instruments are well known to the skilled person in the art. Preferably, particle size is determined using a Beckman Coulter RAPIDVUE™ instrument (Beckman Coulter Particle Characterization, Miami, Fla., USA). The particle size distribution is not critical and in some embodiments is characterized as being monodispersed, Gaussian, or random.

The terms “ultrahigh-surface area exfoliated graphite” and “UHSA exfoliated graphite” are synonymous and mean a mixture comprising single aromatic sheets of sp²-bonded carbon atoms (i.e., graphene per se, wherein the sheet is 1 carbon atom thick), multiple-sheet stacks thereof (each multiple-sheet stack having two or more sheets and on average at least one dimension that is less than 100 nm), or any combination thereof, that are not in cylinder form (i.e., not a carbon nanotube). The UHSA exfoliated graphite is further described later.

Unless otherwise noted, the phrase “Periodic Table of the Elements” refers to the periodic table, version dated Jun. 22, 2007, published by the International Union of Pure and Applied Chemistry (IUPAC).

The term “T_{g}” means glass transition temperature as determined by differential scanning calorimetry (DSC).

The term “Tₘ” means melting temperature as determined by DSC. If a MSA material has one or more Tₘ, preferably at least one Tₘ is 25° C. or higher.

For purposes herein, determine T_{g} and Tₘ according to the following procedure. Load a sample weighing between 5 milligrams (mg) and 10 mg into an aluminum hermetic DSC pan. Sequentially expose the sample to a first heating scan, holding step, cooling step, and a second heating scan. Particularly, in the first heating scan, heat the sample to 200° C. at a heating rate of 10° C. per minute. Hold the sample at 200° C. for 1 minute, and then cool the sample to −80° C. at a cooling rate of 10° C. per minute. Then in the second heating scan, heat the cooled sample to 200° C. at a heating rate of 10° C. per minute. Determine thermal events such as T_{g} and Tₘ from the second heating scan.

The term “viscosity” means zero shear viscosity unless specified otherwise.

### Carbon Fillers

When the carbon filler comprises a graphite (natural or synthetic) or expanded graphite, preferably the graphite or expanded graphite is a commercially available material such as, for example, that available from Superior Graphite Company, Chicago, Ill., USA; GRAFTech Inc., Advanced Energy Technologies Division, Parma, Ohio, USA; or Vorbeck Materials, Jessup, Md., USA.

### Ultrahigh-Surface Area Exfoliated Graphite

UHSA exfoliated graphite useful in the present invention has a BET surface area of from 120 m²/g to about 2630 m²/g, the theoretical BET surface area of graphene. A practical upper limit of the BET surface area is currently about 1600 m²/g based on current methods of making UHSA exfoliated graphite. In some embodiments, the upper limit of the BET surface area is about 1500 m²/g. Preferably, the BET surface area is at least 250 m²/g, more preferably at least about 400 m²/g, still more preferably at least about 650 m²/g, even more preferably at least about 700 m²/g. For purposes of this invention, the BET surface area measurement is made 77° K. using 30% nitrogen in helium, at a P/P₀ ratio of 0.3. A variety of commercially available devices are useful for measuring BET surface area, including a Micromeritics TRISTAR 3000 device and a Quantachrome Monosorb tester. Samples are suitably outgassed prior to making the measurements, with suitable conditions being 200 degrees Celsius (° C.) at atmospheric pressure. An average of multiple data points are used to determine the BET value.

Wide angle X-ray spectroscopy (WAXS) is another method of characterizing degree of exfoliation of UHSA exfoliated graphite. WAXS is conveniently performed for purposes of this invention using a Bruker D-8 or Rigaku MiniFlex diffractometer with a Cu Kα radiation source, although other commercially available diffractometers may be used instead. As a baseline for comparison, a typical natural or synthetic starting graphite (unexfoliated) exhibits an intense crystalline peak at a d-spacing of about 3.36±0.02 Angstroms (Å) (about 26.5 degrees 2θ for copper Kα radiation). This peak is associated with the intra-planar spacing of the starting graphite, which is typically on the order of 0.34 nanometers (nm). Conventional exfoliation of starting graphite leads to a separation of at least some of its layers to give various conventional exfoliated graphites. The separation of the layers during exfoliation typically leads to a shift of the 3.36±0.02 Å peak and a diminution of its intensity. The intensity of the 3.36±0.02 Å peak in the conventional exfoliated graphites is an indication of the degree to which this inter-planar spacing is retained. Preferably, UHSA exfoliated graphite exhibits no measurable peak at 3.36±0.02 Å d-spacing that corresponds to graphite inter-layer spacing. More preferably, UHSA exfoliated graphite exhibits no measurable peak at 3.36±0.02 Å d-spacing that corresponds to graphite inter-layer spacing and has a BET surface area as described in any one of the embodiments of the immediately preceding paragraph.

Exfoliation of graphite tends to increase volume per unit weight of the resulting UHSA exfoliated graphite compared to the graphite. The UHSA exfoliated graphite preferably is one that has been exfoliated to a volume of at least 100 cubic centimeters per gram (cc/g), more preferably at least 200 cc/g, and still more preferably at least 300 cc/g. Post-expansion treatments such as milling, grinding, compaction, or a combination thereof may effect, typically decrease, the volume of the UHSA exfoliated graphite.

UHSA exfoliated graphite preferably is prepared from a naturally-occurring or synthetic starting graphite (flakes, powders, or a mixture thereof) or from an expandable graphite. Examples of suitable expandable graphites are commercially available under the trade names GRAFGuard® 160-50N (from GRAFTech Inc., Advanced Energy Technologies Division, Parma, Ohio) and HP-50 (from HP Material Solutions, Northridge, Calif.). Preferably, the graphite or expandable graphite consists essentially of particles having sizes characterized as being −10 mesh or a higher mesh number (e.g., −100 mesh graphite). A −10 mesh graphite means graphite that can pass through a −10 mesh screen. More preferably, the graphite consists essentially of particles having sizes characterized as being about −100 mesh or a higher mesh number, still more preferably about −300 mesh or a higher mesh number. Particle size and mesh number are inversely related.

PCT IPAPN WO 2007/047084 shows that the long-known Staudenmaier synthesis using mixed concentrated sulfuric and nitric acids (Staudenmaier, L., Ber. Dtsh. Chem. Ges., 1898, 31, 1484), when combined with a high potassium chlorate concentration, provides an oxidizing slurry for the oxidation/intercalation of starting graphite to produce a graphite oxide.

Conventional thermal treatment (heating) of the graphite oxide of PCT IPAPN WO 2007/047084 is one method of forming the UHSA exfoliated graphite.

In an example of a method of intercalating the starting graphite, the starting graphite is first treated with an excess of a mineral acid, preferably a mixture of nitric and sulfuric acids, optionally in the presence of an organic acid and/or reducing agent to give an acid/graphite mixture. “Excess” in this context means an amount greater than can be absorbed by the graphite. In some embodiments, this treatment is repeated one or more times. Oxidant potassium chlorate and/or potassium permanganate is then added to the acid/graphite mixture, preferably controlling any exotherm to prevent premature vaporization and/or reaction of the intercalating agents. The potassium chlorate or permanganate dissolves into the acid and is carried into the layer structure of the starting graphite. The mixture is conveniently maintained at about room temperature for a period of about 4 hours to 200 hours or more, particularly, 10 hours to 150 hours and especially 20 hours to 120 hours. The acids, oxidants, and any reaction products thereof are collectively referred to herein as intercalating materials. In some embodiments, higher temperatures are used if the intercalating materials essentially do not volatilize or react.

The ability to form UHSA exfoliated graphite having surface areas of 120 m²/g or larger appears to be directly proportional to the length of time that the starting graphite is exposed to the intercalating materials. After the intercalation process is complete, the resulting intercalated graphite product is conveniently washed with water and/or mineral acid solution, filtered and dried. Drying conditions are preferably mild, such as a temperature of 60° C. or less and atmospheric pressure, in order to prevent premature exfoliation of the intercalated graphite through the volatilization or degradation of the intercalating materials.

Exfoliating the intercalated graphite to give UHSA exfoliated graphite is typically performed by heating it at exfoliation temperatures in the range of 160° C. to about 1100° C. or more. Preferably, the exfoliation temperature is in the range of 600° C. to 1100° C., more 900° C. to 1100° C. The intercalated graphite particles are preferably heated very rapidly to the exfoliation temperature. In some embodiments, heating is performed in a manner such as, for example, by placing the intercalated graphite into a heated oven or by applying microwave energy to the intercalated graphite.

The intercalating materials tend to comprise strong oxidants, and the UHSA exfoliated graphite tends to be somewhat oxidized. A UHSA exfoliated graphite having a degree of oxidation is within the scope of the present invention. In some embodiments, the intercalated graphite contains up to about 50% oxygen by weight (of the graphite less intercalating materials). A typical amount of oxygen in a sample of the intercalated graphite is from 20% by weight to 40% by weight. During the exfoliation process, some of this oxygen is lost in the form of water, carbon dioxide and other species, so the UHSA exfoliated graphite more typically contains from about 10% by weight to about 25% by weight oxygen.

In an even more preferred process, which is described in PCT International Patent Application Number PCT/US2008/071326, the intercalated graphite (i.e., “oxidized graphite”) is prepared by mixing in a reaction vessel a reaction mixture comprising concentrated sulfuric acid, concentrated nitric acid, a sodium chlorate, and a starting graphite, wherein when the sodium chlorate is solid sodium chlorate, temperature of the reaction mixture is 40 degrees Celsius (° C.) or higher and, preferably, 100° C. or lower, more preferably 55° C. or lower. Still more preferably, the sodium chlorate is aqueous sodium chlorate. Preferably, the aqueous sodium chlorate has a sodium chlorate concentration of at least 0.1 molar (i.e., 0.1 moles of sodium chlorate per liter of aqueous sodium chlorate) up to a saturated solution, i.e., the concentration at saturation of sodium chlorate in water at 25° C. In other embodiments, the sodium chlorate concentration is 8 molar or less.

The above processes typically produce UHSA exfoliated graphite in the form of particles. The UHSA exfoliated graphite particles typically assume a vermiform (worm-like) appearance, with a longest worm-like particle size generally in the range of about 0.1 millimeters (mm) to about 10 mm. In some embodiments, the worm-like UHSA exfoliated graphite particles are used directly without further treatment or milled to produce milled UHSA exfoliated graphite particles having smaller particle sizes. Milled UHSA exfoliated graphite particles preferably lack a worm-like appearance. In some embodiments, the UHSA exfoliated graphite comprises graphene sheets sold under the trademark Vor-x™ (Vorbeck Materials, Jessup, Md., USA).

### Molecularly Self-Assembling Material

As used herein a MSA material means an oligomer or polymer that effectively forms larger associated or assembled oligomers and/or polymers through the physical intermolecular associations of chemical functional groups. Without wishing to be bound by theory, it is believed that the intermolecular associations do not increase the molecular weight (Mn-Number Average molecular weight) or chain length of the self-assembling material and covalent bonds between said materials do not form. This combining or assembling occurs spontaneously upon a triggering event such as cooling to form the larger associated or assembled oligomer or polymer structures. Examples of other triggering events are the shear-induced crystallizing of, and contacting a nucleating agent to, a molecularly self-assembling material. Accordingly, in preferred embodiments MSAs exhibit mechanical properties similar to some higher molecular weight synthetic polymers and viscosities like very low molecular weight compounds. MSA organization (self-assembly) is caused by non-covalent bonding interactions, often directional, between molecular functional groups or moieties located on individual molecular (i.e. oligomer or polymer) repeat units (e.g. hydrogen-bonded arrays). Non-covalent bonding interactions include: electrostatic interactions (ion-ion, ion-dipole or dipole-dipole), coordinative metal-ligand bonding, hydrogen bonding, π-π-structure stacking interactions, donor-acceptor, and/or van der Waals forces and can occur intra- and intermolecularly to impart structural order. One preferred mode of self-assembly is hydrogen-bonding and this non-covalent bonding interactions is defined by a mathematical “Association constant”, K(assoc) constant describing the relative energetic interaction strength of a chemical complex or group of complexes having multiple hydrogen bonds. Such complexes give rise to the higher-ordered structures in a mass of MSA materials. A description of self assembling multiple H-bonding arrays can be found in “Supramolecular Polymers”, Alberto Ciferri Ed., 2nd Edition, pages (pp) 157-158. A “hydrogen bonding array” is a purposely synthesized set (or group) of chemical moieties (e.g. carbonyl, amine, amide, hydroxyl. etc.) covalently bonded on repeating structures or units to prepare a self assembling molecule so that the individual chemical moieties preferably form self assembling donor-acceptor pairs with other donors and acceptors on the same, or different, molecule. A “hydrogen bonded complex” is a chemical complex formed between hydrogen bonding arrays. Hydrogen bonded arrays can have association constants K (assoc) between 10² and 10⁹ M⁻¹ (reciprocal molarities), generally greater than 10³ M⁻¹. In preferred embodiments, the arrays are chemically the same or different and form complexes.

Accordingly, the molecularly self-assembling materials (MSA) presently include: molecularly self-assembling polyesteramides, copolyesteramide, copolyetheramide, copolyetherester-amide, copolyetherester-urethane, copolyether-urethane, copolyester-urethane, copolyester-urea, copolyetherester-urea and their mixtures. Preferred MSA include copolyesteramide, copolyether-amide, copolyester-urethane, and copolyether-urethanes. The MSA preferably has number average molecular weights, MWₙ (interchangeably referred to as Mₙ) (as is preferably determined by NMR spectroscopy) of 2000 grams per mole or more, more preferably at least about 3000 g/mol, and even more preferably at least about 5000 g/mol. The MSA preferably has MWₙ 50,000 g/mol or less, more preferably about 20,000 g/mol or less, yet more preferably about 15,000 g/mol or less, and even more preferably about 12,000 g/mol or less. The MSA material preferably comprises molecularly self-assembling repeat units, more preferably comprising (multiple) hydrogen bonding arrays, wherein the arrays have an association constant K (assoc) preferably from 10² to 10⁹ reciprocal molarity (M⁻¹) and still more preferably greater than 10³ M⁻¹; association of multiple-hydrogen-bonding arrays comprising donor-acceptor hydrogen bonding moieties is the preferred mode of self assembly. The multiple H-bonding arrays preferably comprise an average of 2 to 8, more preferably 4-6, and still more preferably at least 4 donor-acceptor hydrogen bonding moieties per molecularly self-assembling unit. Molecularly self-assembling units in preferred MSA materials include bis-amide groups, and bis-urethane group repeat units and their higher oligomers.

Preferred self-assembling units in the MSA material useful in the present invention are bis-amides, bis-urethanes and bis-urea units or their higher oligomers. A more preferred self-assembling unit comprises a poly(ester-amide), poly(ether-amide), poly(ester-urea), poly(ether-urea), poly(ester-urethane), or poly(ether-urethane), or a mixture thereof. For convenience and unless stated otherwise, oligomers or polymers comprising the MSA materials may simply be referred to herein as polymers, which includes homopolymers and interpolymers such as co-polymers, terpolymers, etc.

In some embodiments, the MSA materials include “non-aromatic hydrocarbylene groups” and this term means specifically herein hydrocarbylene groups (a divalent radical formed by removing two hydrogen atoms from a hydrocarbon) not having or including any aromatic structures such as aromatic rings (e.g. phenyl) in the backbone of the oligomer or polymer repeating units. In some embodiments, non-aromatic hydrocarbylene groups are optionally substituted with various substituents, or functional groups, including but not limited to: halides, alkoxy groups, hydroxy groups, thiol groups, ester groups, ketone groups, carboxylic acid groups, amines, and amides. A “non-aromatic heterohydrocarbylene” is a hydrocarbylene that includes at least one non-carbon atom (e.g. N, O, S, P or other heteroatom) in the backbone of the polymer or oligomer chain, and that does not have or include aromatic structures (e.g., aromatic rings) in the backbone of the polymer or oligomer chain. In some embodiments, non-aromatic heterohydrocarbylene groups are optionally substituted with various substituents, or functional groups, including but not limited to: halides, alkoxy groups, hydroxy groups, thiol groups, ester groups, ketone groups, carboxylic acid groups, amines, and amides. Heteroalkylene is an alkylene group having at least one non-carbon atom (e.g. N, O, S or other heteroatom) that, in some embodiments, is optionally substituted with various substituents, or functional groups, including but not limited to: halides, alkoxy groups, hydroxy groups, thiol groups, ester groups, ketone groups, carboxylic acid groups, amines, and amides. For the purpose of this disclosure, a “cycloalkyl” group is a saturated carbocyclic radical having three to twelve carbon atoms, preferably three to seven. A “cycloalkylene” group is an unsaturated carbocyclic radical having three to twelve carbon atoms, preferably three to seven. Cycloalkyl and cycloalkylene groups independently are monocyclic or polycyclic fused systems as long as no aromatics are included. Examples of carbocyclic radicals include cyclopropyl, cyclobutyl, cyclopentyl, cyclohexyl and cycloheptyl. In some embodiments, the groups herein are optionally substituted in one or more substitutable positions as would be known in the art. For example in some embodiments, cycloalkyl and cycloalkylene groups are optionally substituted with, among others, halides, alkoxy groups, hydroxy groups, thiol groups, ester groups, ketone groups, carboxylic acid groups, amines, and amides. In some embodiments, cycloalkyl and cycloalkene groups are optionally incorporated into combinations with other groups to form additional substituent groups, for example: “-Alkylene-cycloalkylene-, “-alkylene-cycloalkylene-alkylene-”, “-heteroalkylene-cycloalkylene-”, and “-heteroalkylene-cycloalkyl-heteroalkylene” which refer to various non-limiting combinations of alkyl, heteroalkyl, and cycloalkyl. These combinations include groups such as oxydialkylenes (e.g., diethylene glycol), groups derived from branched diols such as neopentyl glycol or derived from cyclo-hydrocarbylene diols such as Dow Chemical's UNOXOL® isomer mixture of 1,3- and 1,4-cyclohexanedimethanol, and other non-limiting groups, such -methylcylohexyl-, -methyl-cyclohexyl-methyl-, and the like. “Heterocycloalkyl” is one or more cyclic ring systems having 4 to 12 atoms and, containing carbon atoms and at least one and up to four heteroatoms selected from nitrogen, oxygen, or sulfur. Heterocycloalkyl includes fused ring structures. Preferred heterocyclic groups contain two ring nitrogen atoms, such as piperazinyl. In some embodiments, the heterocycloalkyl groups herein are optionally substituted in one or more substitutable positions. For example in some embodiments, heterocycloalkyl groups are optionally substituted with halides, alkoxy groups, hydroxy groups, thiol groups, ester groups, ketone groups, carboxylic acid groups, amines, and amides.

Examples of MSA materials useful in the present invention are poly(ester-amides), poly(ether-amides), poly(ester-ureas), poly(ether-ureas), poly(ester-urethanes), and poly(ether-urethanes), and mixtures thereof that are described, with preparations thereof, in United States Patent Number (USPN) U.S. Pat. No. 6,172,167; and applicant's co-pending PCT application numbers PCT/US2006/023450, which was renumbered as PCT/US2006/004005 and published under PCT International Patent Application Number (PCT-IPAPN) WO 2007/099397 and U.S. Patent Application Publication Number (USPAPN) 2008-0214743; PCT/US2006/035201, which published under PCT-IPAPN WO 2007/030791; PCT/US08/053,917, which published under PCT-IPAPN WO 2008/101051; PCT/US08/056,754, which published under PCT-IPAPN WO 2008/112833; and PCT/US08/065,242. Preferred said MSA materials are described below.

In a set of preferred embodiments, the molecularly self-assembling material comprises ester repeat units of Formula I:

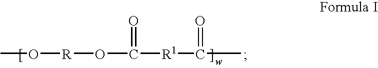

and at least one second repeat unit selected from the esteramide units of Formula II and III:

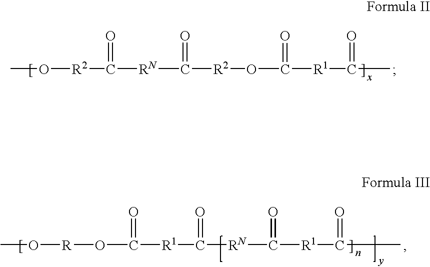

and the ester-urethane units of Formula IV:

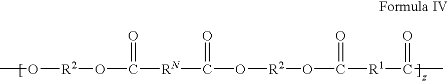

wherein

R is at each occurrence, independently a C₂-C₂₀ non-aromatic hydrocarbylene group, a C₂-C₂₀ non-aromatic heterohydrocarbylene group, or a polyalkylene oxide group having a group molecular weight of from about 100 to about 5000 g/mol. In preferred embodiments, the C₂-C₂₀ non-aromatic hydrocarbylene at each occurrence is independently specific groups: alkylene-, -cycloalkylene-, -alkylene-cycloalkylene-, -alkylene-cycloalkylene-alkylene-(including dimethylene cyclohexyl groups). Preferably, these aforementioned specific groups are from 2 to 12 carbon atoms, more preferably from 3 to 7 carbon atoms. The C₂-C₂₀ non-aromatic heterohydrocarbylene groups are at each occurrence, independently specifically groups, non-limiting examples including: -hetereoalkylene-, -heteroalkylene-cycloalkylene-, -cycloalkylene-heteroalkylene-, or -heteroalkylene-cycloalkylene-heteroalkylene-, each aforementioned specific group preferably comprising from 2 to 12 carbon atoms, more preferably from 3 to 7 carbon atoms. Preferred heteroalkylene groups include oxydialkylenes, for example diethylene glycol (—CH₂CH₂OCH₂CH₂—O—). When R is a polyalkylene oxide group it preferably is a polytetramethylene ether, polypropylene oxide, polyethylene oxide, or their combinations in random or block configuration wherein the molecular weight (Mn—average molecular weight, or conventional molecular weight) is preferably about 250 g/ml to 5000, g/mol, more preferably more than 280 g/mol, and still more preferably more than 500 g/mol, and is preferably less than 3000 g/mol; in some embodiments, mixed length alkylene oxides are included. Other preferred embodiments include species where R is the same C₂-C₆ alkylene group at each occurrence, and most preferably it is —(CH₂)₄—.

R¹ is at each occurrence, independently, a bond, or a C₁-C₂₀ non-aromatic hydrocarbylene group. In some preferred embodiments, R¹ is the same C₁-C₆ alkylene group at each occurrence, most preferably —(CH₂)₄—.

R² is at each occurrence, independently, a C₁-C₂₀ non-aromatic hydrocarbylene group. According to another embodiment, R² is the same at each occurrence, preferably C₁-C₆ alkylene, and even more preferably R² is —(CH₂)₂—, —(CH₂)₃—, —(CH₂)₄—, or —(CH₂)₅—.

R^{N} is at each occurrence —N(R³)—Ra—N(R³)—, where R³ is independently H or a C₁-C₆ alkyl, preferably C₁-C₄ alkyl, or R^{N} is a C₂-C₂₀ heterocycloalkylene group containing the two nitrogen atoms, wherein each nitrogen atom is bonded to a carbonyl group according to Formula II or III above; w represents the ester mol fraction, and x, y and z represent the amide or urethane mole fractions where w+x+y+z=1, 0<w<1, and at least one of x, y and z is greater than zero. Ra is a C₂-C₂₀ non-aromatic hydrocarbylene group, more preferably a C₂-C₁₂ alkylene: most preferred Ra groups are ethylene butylene, and hexylene —(CH₂)₆—. In some embodiments, R^{N} is piperazin-1,4-diyl. According to another embodiment, both R³ groups are hydrogen.

n is at least 1 and has a mean value less than 2.

In an alternative embodiment, the MSA is a polymer consisting of repeat units of either Formula II or Formula III, wherein R, R¹, R², R^{N}, and n are as defined above and x and y are mole fractions wherein x+y=1, and 0≦x≦1 and 0≦y≦1.

In certain embodiments comprising polyesteramides of Formula I and II, or Formula I, II, and III, particularly preferred materials are those wherein R is —(C₂-C₆)-alkylene, especially —(CH₂)₄—. Also preferred are materials wherein R¹ at each occurrence is the same and is C₁-C₆ alkylene, especially —(CH₂)₄—. Further preferred are materials wherein R² at each occurrence is the same and is —(C₁-C₆)-alkylene, especially —(CH₂)₅— alkylene. The polyesteramide according to this embodiment preferably has a number average molecular weight (Mn) of at least about 4000, and no more than about 20,000. More preferably, the molecular weight is no more than about 12,000.

For convenience the chemical repeat units for various embodiments are shown independently. The invention encompasses all possible distributions of the w, x, y, and z units in the copolymers, including randomly distributed w, x, y and z units, alternatingly distributed w, x, y and z units, as well as partially, and block or segmented copolymers, the definition of these kinds of copolymers being used in the conventional manner as known in the art. Additionally, there are no particular limitations in the invention on the fraction of the various units, provided that the copolymer contains at least one w and at least one x, y, or z unit. In some embodiments, the mole fraction of w to (x+y+z) units is between about 0.1:0.9 and about 0.9:0.1. In some preferred embodiments, the copolymer comprises at least 15 mole percent w units, at least 25 mole percent w units, or at least 50 mole percent w units

In some embodiments, the number average molecular weight (Mₙ) of the MSA material useful in the present invention is between 1000 g/mol and 30,000 g/mol, inclusive. In some embodiments, Mₙ of the MSA material is between 2,000 g/mol and 20,000 g/mol, inclusive, preferably 5,000 g/mol to 12,000 g/mol. In more preferred embodiments, Mₙ of the MSA material is less than 5,000 g/mol. Thus, in some more preferred embodiments, Mₙ of the MSA material is at least about 1000 g/mol and 4,900 g/mol or less, more preferably 4,500 g/mol or less.

Viscosity of a melt of a preferred MSA material is characterized as being Newtonian over the frequency range of 10⁻¹ to 10² radians per second (rad./s.) at a temperature from above a melting temperature Tₘ up to about 40 degrees Celsius (° C.) above Tₘ, preferably as determined by differential scanning calorimetry (DSC). Depending upon the polymer or oligomer, preferred MSA materials exhibit Newtonian viscosity in the test range frequency at temperatures above 100° C., more preferably above 120° C. and more preferably still at or above 140° C. and preferably less than 300° C., more preferably less than 250° C. and more preferably still less than 200° C. For the purposes of the present disclosure, the term Newtonian has its conventional meaning; that is, approximately a constant viscosity with increasing (or decreasing) shear rate of a (MSA) material at a constant testing temperature. The zero shear viscosity of a preferred MSA material is in the range of from 0.1 Pa·s. to 1000 Pa·s., preferably from 0.1 Pa·s. to 100 Pa·s., more preferably from 0.1 to 30 Pa·s., still more preferred 0.1 Pa·s. to 10 Pa·s., between the temperature range of 180° C. and 220° C., e.g., 180° C. and 190° C.

Preferably, the viscosity of a melt of a MSA material useful in the present invention is less than 100 Pa·s. at from above Tₘ up to about 40° C. above Tₘ. The viscosity of one of the preferred MSA materials is less than 100 Pa·s. at 190° C., and more preferably in the range of from 1 Pa·s. to 50 Pa·s. at 150° C. to 180° C. Preferably, the glass transition temperature of the MSA material is less than 20° C. Preferably, the melting temperature is higher than 60° C. Preferred MSA materials exhibit multiple glass transition temperatures T_{g}. Preferably, the MSA material has a T_{g} that is higher than −80° C. Also preferably, the MSA material has a T_{g} that is higher than −60° C.

Tensile modulus of one preferred group of MSA materials is preferably from 4 megapascals (MPa) to 500 MPa at room temperature, preferably 20° C. Tensile modulus testing is well known in the polymer arts.

Preferably, torsional (dynamic) storage modulus of MSA materials useful in the invention is at least 100 MPa at 20° C. More preferably, the storage modulus is at least 200 MPa, still more preferably at least 300 MPa, and even more preferably greater than 400 MPa, all at 20° C.

Preferably, polydispersities of substantially linear MSA materials useful in the present invention is 4 or less, more preferably 3 or less, still more preferably 2.5 or less, still more preferably 2.2 or less.

In some embodiments, the polymers described herein are modified with, for example and without limitation thereto, other polymers, resins, tackifiers, fillers, oils and additives (e.g. flame retardants, antioxidants, pigments, dyes, and the like).

### The Polymer Carbon Composite

A preferred polymer carbon composite of the first embodiment is characterized, when its MSA material is a melt, as having a zero shear viscosity of less than 10,000,000 Pa·s., more preferably 1,000,000 Pa·s. or less, still more preferably 1000 Pa·s. or less, and even more preferably 500 Pa·s. or less at from above Tₘ up to about 40° C. above Tₘ of the MSA material, preferably from 150° C. to 180° C.

### The Polymer Carbon Filler Composite

Preferably, the carbon filler comprises a total of at least 2 wt %, more preferably at least 3 wt %, and still more preferably at least 5 wt % of the polymer carbon composite of the first embodiment. Also preferably, the carbon filler comprises a total of about 50 wt % or less, more preferably about 40 wt % or less, and still more preferably about 30 wt % or less of the polymer carbon composite of the first embodiment.

In some embodiments, the presence of the carbon filler will significantly increase dielectric constant (i.e., relative static permittivity), loss factor, or both at 1000 Hertz (Hz) or 100,000 Hz, or conductivity (Siemens per meter (S/m)), of the respective polymer carbon composite of the first embodiment, relative to that of the relevant MSA material alone. For purposes of the present invention, dielectric constant and loss factor are measured using a TA Instruments Thermal Analysis DEA Ceramic Parallel Plates and ISO 25C test method. For purposes of the present invention, conductivity is measured using an Electro-tech Systems, Inc. Model 880 Resistance meter and Fluke 77 digital volt multimeter. An extent to which this increase occurs depends on factors such as the particular MSA material employed, loading of the carbon filler in the respective composite, how well particles of the carbon filler are distributed within the MSA material, and other factors. Preferably, the relative static permittivity, loss factor, or conductivity of the polymer carbon composite of the first embodiment is increased by 5 times or more, preferably 1 or more orders of magnitude compared to the relative static permittivity, loss factor, conductivity, or any combination thereof of the MSA material alone.

### The Process of Making the Polymer Carbon Composite

Preferably, temperature of the melt comprising the MSA material during the dispersing of carbon filler therein is less than 250° C., more preferably less than 200° C., and still more preferably less than 180° C.

### Materials and Methods

### Materials

A graphite series ABG 1045 is obtained from Superior Graphite Company.

Ultrahigh-surface area expanded graphite is prepared according to a procedure analogous to the procedure of Example 1 of USPAPN US 2008-0171824 A1, which Example 1 is hereby incorporated by reference herein.

### Determining Copolymer Number Average Molecular Weight (Mₙ)

Proton nuclear magnetic resonance spectroscopy (proton NMR or ¹H-NMR) is used to determine monomer purity, copolymer composition, and copolymer number average molecular weight Mₙ utilizing the CH₂OH end groups. Proton NMR assignments are dependent on the specific structure being analyzed as well as the solvent, concentration, and temperatures utilized for measurement. For ester amide monomers and co-polyesteramides, d4-acetic acid is a convenient solvent and is the solvent used unless otherwise noted. For ester amide monomers of the type called DD that are methyl esters typical peak assignments are about 3.6 to 3.7 ppm for C(═O)—OCH₃; about 3.2 to 3.3 ppm for N—CH₂—; about 2.2 to 2.4 ppm for C(═O)—CH₂—; and about 1.2 to 1.7 ppm for C—CH₂—C. For co-polyesteramides that are based on DD with 1,4-butanediol, typical peak assignments are about 4.1 to 4.2 ppm for C(═O)—OCH₂—; about 3.2 to 3.4 ppm for N—CH₂—; about 2.2 to 2.5 ppm for C(═O)—CH₂—; about 1.2 to 1.8 ppm for C—CH₂—C, and about 3.6 to 3.75 —CH₂OH end groups.

### Calculating Weight Percents (wt %) of Composites

Weight percents (wt %) of ingredients of the composites of the Comparative Examples and Examples of the Present Invention described below are based on total weight of the respective composites.

### Compounding Procedures for Preparing Polymer Carbon Composites

Prior to compounding, all MSA materials and filler materials are pre-weighed and stored separately. In the following procedure, the MSA materials and filler materials are not dried before blending.

A carbon filler sample is weighed on a pre-weighed melt blown sheet of a MSA material. Then additional melt blown sheets of the MSA material are wrapped around the carbon filler until appropriate weights of the carbon filler and the MSA material are obtained. The resulting materials are heated together to 160° C. under vacuum for 2.5 hours so that the MSA material melts around the carbon filler, and the resulting base melt is allowed to cool and solidify to a base solid. Samples are die cut from the base solid that are sufficiently small to fit in a Haake PolyLab Rheocord blender.

A Haake PolyLab Rheocord blender (Haake) is outfitted with a 20 milliliter (mL) bowl. Temperatures of all zones of the Haake mixer are set to 160° C. An air cooling hose is attached to the central one of the zones in order to maintain temperature control. The base solid is loaded into the 20 mL bowl and allowed to melt. Then, a plunger is lowered into the Haake, and the melt of the MSA material and carbon filler is compounded at a rotor speed of 200 revolutions per minute (rpm), and a residence time of approximately 2.5 minutes. The residence time begins with the lowering of the plunger, and ends with the raising the plunger. Table 1 presents the timing for the compounding.

TABLE 1
Summary of composite compounding procedure

| Time | rpm | Comment |
|---|---|---|
| 0 second | 200 | |
| 10 seconds | 50 | Add base solid |
| 1 minute 10 seconds | 200 | Allow base solid to melt |
| 2 minutes 30 seconds | 200 | Compound to give carbon filler composite |
| 5 minutes | 0 | Recover carbon filler composite |

### Compression Molding:

Prior to molding, all samples are allowed to dry overnight (at least 16 hours) at 65° C. in a vacuum of approximately 36 cmHg (48 kiloPascals (kPa)). Samples are compression molded into 10 cm×10 cm×0.05 cm plaques and 5 cm×1.25 cm×0.32 cm bars unless otherwise noted. Compression molding is done using a MPT-14 compression/lamination press (Tetrahedron Associates, Inc., San Diego, Calif., USA) having a molder and mold chase. The procedure is summarized in Table 2.

TABLE 2
Summary of compression molding parameters

| | | | | Load ramp | |
|---|---|---|---|---|---|
| | Temper- | Temperature | | rate, | |
| | ature | ramp rate | Load, kg | kg/minute | Time |
| Step | (° C.) | (° C./minute) | (klb) | (klb/min) | (minutes) |
| 1 | 140 | 93 | 608 (1.5) | 317 × 10³ | 5 |
| | | | | (1200) | |
| 2 | 140 | 93 | 4536 (10) | 317 × 10³ | 4 |
| | | | | (1200) | |
| 3 | 140 | 93 | 18143 (40) | 317 × 10³ | 3 |
| | | | | (1200) | |
| 4 | 37.8 | 93 | 450 (1) | 317 × 10³ | 5 |
| | | | | (1200) | |
| 5 | End | | | | |

### Thermogravimetric Analysis (TGA) Procedure

Samples weighing between 5 milligrams (mg) and 10 mg are loaded into an aluminum TGA pan and heated to 500° C. at a rate of 10° C./minute in a TA Instruments Q5000 TGA in a nitrogen gas atmosphere. TGA is used to determine actual concentration of inorganics in a composite. Plot results as weight percent (weight %) versus temperature (° C.), wherein weight percent means residual weight of a sample as a percent of original weight of the sample.

### Melt Viscosity Measurement Procedure

Samples are die cut from a plaque of composite. Parallel plate geometry holders in an Ares Rheometer (TA Instruments) are heated to 170° C. The holders are zeroed at temperature. A sample is loaded onto the holders, and the top holder is lowered into that sample so that there is significant normal force on the sample. The sample is allowed to melt, and any melted sample that extends beyond the holders is removed. Initially, a dynamic strain sweep is conducted at 1 Hz and 170° C. beginning at a strain of 0.1%. For each sample, a strain value is obtained from a region where dynamic loss shear modulus (G″) is linear over a range of strain values. This strain value is used for subsequent dynamic frequency sweeps. Using the strain value obtained during the strain sweep, a frequency sweep is conducted at 170° C. The frequency ranged from 100 rad/s. to 0.1 rad/s. Plot results as viscosity in Pascal-seconds (Pa·s.) versus frequency in radians per second (rad/s.).

Dielectric constants (i.e., relative static permittivities) and loss factors

Samples of about 2.5 cm×2.5 cm×0.05 cm (1 inch×1 inch×0.02 inch) are tested for dielectric constants and loss factors at 1000 Hertz and 100,000 Hertz and 25° C. using a TA instruments Thermal Analysis DEA Ceramic Parallel Plates using the ISO 25C test method.

### Volume Resistivity Measurements (1/Conductivity)

Volume resistivity measurements are made using an Electro-tech Systems, Inc (ETS) Model 880 Resistance meter and Fluke 77 digital volt multimeter (DVM). The relative bulk resistance measurements are obtained by fracturing end strips cut from plaques at liquid nitrogen temperatures and applying conductive silver paint on the resulting broken ends having rough fracture surfaces. Resistance across the silver paint is essentially zero and silver paint is added to ensure contact to the rough fracture surfaces. The paint is then allowed to dry for a minimum of one hour. Measurement of resistivity is made using either the DVM or the ETS meter. Typical dimensions of broken ends are 30 mm×3 mm (⅛″)×10 mm The resistance is calculated from the voltage and amperage using Ohm's Law. The Volume Resistivity is then calculated using the resistance and the geometry of the sample.

### Transmission Electron Microscope (TEM) Imaging

Samples, approximately 0.5 mm in thickness, from the compression molded plaques and mounted in a chuck for ultracryomicrotomy. Cross-sectional to the thickness, the samples are trimmed into a trapezoid and cooled to −100° C. in the microtome. Thin-sections, approximately 80 nm are obtained with a Leica UC6:FC6 cryo-microtome and examined in a JEOL 1230 operating at an accelerating voltage of 120 kilovolts (kV). Digital TEM images of the microstructure are recorded at various magnifications (typically 1,000 times; 10,000 times; and 50,000 times magnification) using a Gatan Multiscan CCD camera. Show magnified TEM images as black-and-white photographs.

### X-Ray Diffraction (XRD)

Wide angle X-ray diffraction (XRD) patterns are recorded on a Bruker AXS D8 X-ray Diffractometer using Ni filtered Cu Kα radiation (λ=1.5406 Å) in the range of 2 Theta (2θ)=1 degrees to 65 degrees at a scanning rate of 1.2 degree/minute with a step size of 0.02 degrees. Samples are affixed to modeling clay situated in a large sample holder, and the height is adjusted to be even with top of the holder by pressing the holder and face of sample down onto a glass microscope slide. Plot results as Intensity in arbitrary units (a.u.) versus 2Theta (degrees).

### Preparations

Preparations 1A, 1B, and 1C: preparation of MSA material that is a polyesteramide (PEA) comprising 50 mole percent of ethylene-N,N′-dihydroxyhexanamide (C2C) monomer (the MSA material is generally designated as a PEA-C2C50%)
Step (a) Preparation of the diamide diol, ethylene-N,N′-dihydroxyhexanamide (C2C) monomer

The C2C diamide diol monomer is prepared by reacting 1.2 kg ethylene diamine (EDA) with 4.56 kilograms (kg) of ε-caprolactone under a nitrogen blanket in a stainless steel reactor equipped with an agitator and a cooling water jacket. An exothermic condensation reaction between the ε-caprolactone and the EDA occurs which causes the temperature to rise gradually to 80 degrees Celsius (° C.). A white deposit forms and the reactor contents solidify, at which the stirring is stopped. The reactor contents are then cooled to 20° C. and are then allowed to rest for 15 hours. The reactor contents are then heated to 140° C. at which temperature the solidified reactor contents melt. The liquid product is then discharged from the reactor into a collecting tray. A nuclear magnetic resonance study of the resulting product shows that the molar concentration of C2C diamide diol in the product exceeds 80 percent. The melting temperature of the C2C diamide diol monomer product is 140° C.

Step (b): Contacting C2C with Dimethyl Adipate (DMA)

A 100 liter single shaft Kneader-Devolatizer reactor equipped with a distillation column and a vacuum pump system is nitrogen purged, and heated under nitrogen atmosphere to 80° C. (based on thermostat). Dimethyl adipate (DMA; 38.324 kg) and C2C diamide diol monomer (31.724 kg) are fed into the kneader. The slurry is stirred at 50 revolutions per minute (rpm).

Step (c): Contacting C2C/DMA with 1,4-butanediol, Distilling Methanol and Transesterification

1,4-Butanediol (18.436 kg) is added to the slurry of Step (b) at a temperature of about 60° C. The reactor temperature is further increased to 145° C. to obtain a homogeneous solution. Still under nitrogen atmosphere, a solution of titanium(IV) butoxide (153 g) in 1.380 kg 1,4-butanediol is injected at a temperature of 145° C. into the reactor, and methanol evolution starts. The temperature in the reactor is slowly increased to 180° C. over 1.75 hours, and is held for 45 additional minutes to complete distillation of methanol at ambient pressure. 12.664 kilograms of methanol are collected.

Step (d): Distilling 1,4-butanediol and Polycondensation to Give PEA-C2C50%

Reactor dome temperature is increased to 130° C. and the vacuum system activated stepwise to a reactor pressure of 7 mbar (0.7 kiloPascals (kPa)) in 1 hour. Temperature in the kneader/devolatizer reactor is kept at 180° C. Then the vacuum is increased to 0.7 mbar (0.07 kPa) for 7 hours while the temperature is increased to 190° C. The reactor is kept for 3 additional hours at 191° C. and with vacuum ranging from 0.87 to 0.75 mbar. At this point a sample of the reactor contents is taken (Preparation 1A); melt viscosities were 6575 megaPascals (MPa) at 180° C. and 5300 MPa at 190° C. The reaction is continued for another 1.5 hours until the final melt viscosities are recorded as 8400 MPa at 180° C. and 6575 MPa at 190° C. (Preparation 1B). Then the liquid Kneader/Devolatizer reactor contents are discharged at high temperature of about 190° C. into collecting trays, the polymer is cooled to room temperature and grinded. Final product is 57.95 kg (87.8% yield) of melt viscosities 8625 MPa at 180° C. and 6725 MPa at 190° C. (Preparation 1C). Preparations 1A to 1C have the data shown below in Table 3.

TABLE 3
Melt viscosities and molecular weights of
samples of MSA Copolyesteramide

| Hours in | | Spindle | Viscosity | Viscosity | Mₙ by |
|---|---|---|---|---|---|
| full | Preparation | No. 28** | at 180° C. | at 190° C. | 1H-NMR |
| vacuum* | Number | (rpm) | (MPa) | (MPa) | (g/mol) |
| 10 | 1A | 20 | 6575 | 5300 | 6450 |
| 11.5 | 1B | 20 | 8400 | 6575 | 6900 |
| 11.5 | 1C | 20 | 8625 | 6725 | 7200 |

*Vacuum < 1.2 mbar
**Viscometer used: Brookfield DV-II+ Viscometer ™

### COMPARATIVE EXAMPLE(S)

### Comparative Example 1

### Unfilled PEA-C2C50% of Preparation 1C

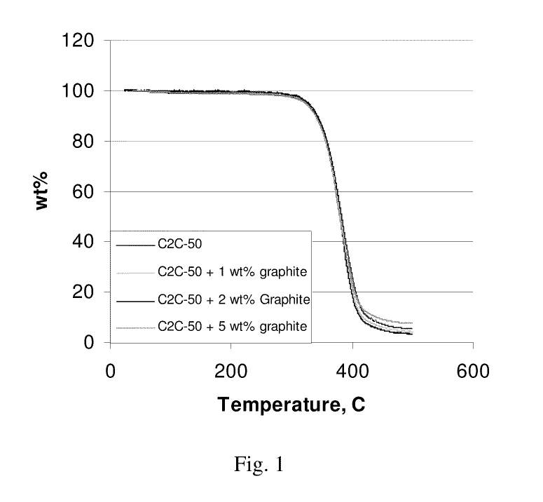

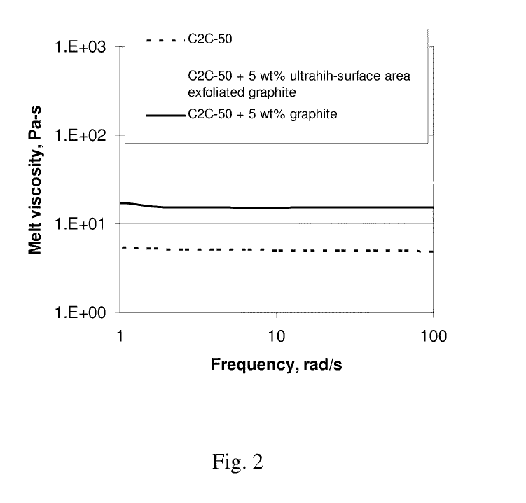

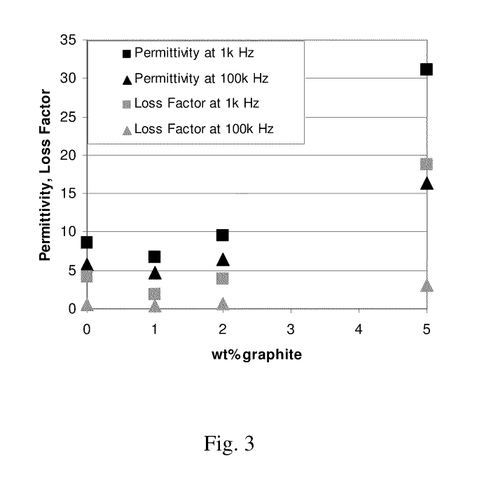

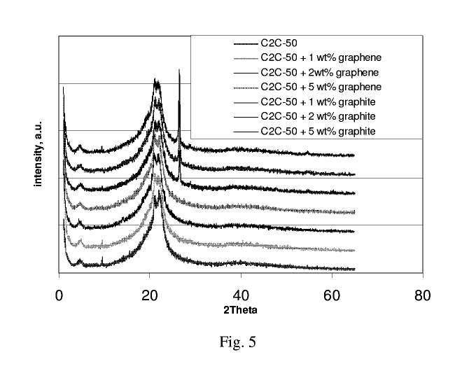

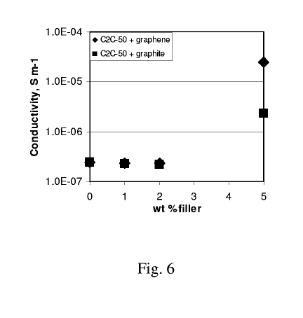

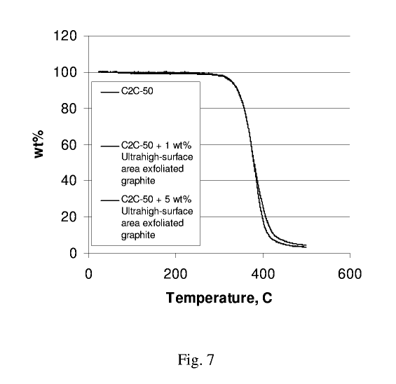

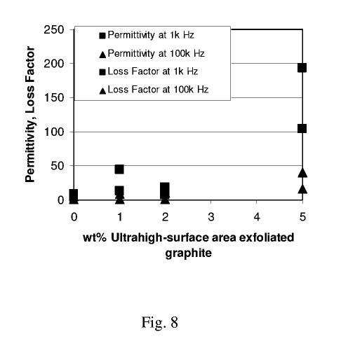

Separate samples of the PEA-C2C50% of Preparation 1C are compression molded, prepared as plaques, or prepared as flat sheets, and subjected to TGA, melt viscosity measurements, relative static permittivity and loss factor measurements, XRD and conductivity measurements according to the procedures described previously. TGA results are shown as parts of FIGS. 1 and 7. Melt viscosity results are shown as part of FIG. 2. Relative static permittivity and loss factor results are shown as parts of FIGS. 3 and 8. XRD results are shown as part of FIG. 5. Conductivity results are shown as part of FIG. 6. In the figures, the unfilled PEA-C2C50% of Preparation 1C is referred to as “C2C-50” or by 0 wt % of graphene or graphite.

### EXAMPLE(S) OF THE PRESENT INVENTION

Example 1A to 1C: Example 1A: composite of 1 wt % graphite and PEA-C2C50% of Preparation 1C; Example 1B: composite of 2 wt % graphite and PEA-C2C50% of Preparation 1C; and Example 1C composite of 5 wt % graphite and PEA-C2C50% of Preparation 1C

Following the above compounding procedure, Haake blending of 1 wt %, 2 wt %, or 5 wt % graphite and PEA-C2C50% of Preparation 1C are separately carried out at 160° C. and 200 rpm to give the composites of Examples 1A to 1C, respectively. Samples of the composites of Examples 1A to 1C are characterized by TGA. The composites of Examples 1A to 1C are separately compression molded as described previously, and the resulting compression moldings characterized by melt viscosity (Example 1C only), dielectric constants (permittivities), loss factors, TEM (Example 1B only), XRD, and conductivity.

The TGA results are shown as parts of FIG. 1, which demonstrate that graphite is dispersed in the composites of Examples 1A to 1C after compounding.

Melt viscosity results are shown as part of FIG. 2. FIG. 2 shows that the melt viscosities of the composite of Example 1C is within the range for processing by conventional melt processing techniques. In FIG. 2, “1.E+03,” for example, means 1 times 10 to the third power.

Dielectric constants (permittivities) and loss factors at 1000 Hertz and 100,000 Hertz are shown as parts of FIG. 3. FIG. 3 shows that dielectric constants (permittivities) and loss factors decrease slightly going from unfilled PEA-C2C50% of Comparative Example 1 to the 1 wt % graphite PEA-C2C50% composite of Example 1A, then increase with subsequently increased loading of 2 wt % and 5 wt % graphite in the graphite PEA-C2C50% composites of Examples 1B and 1C.

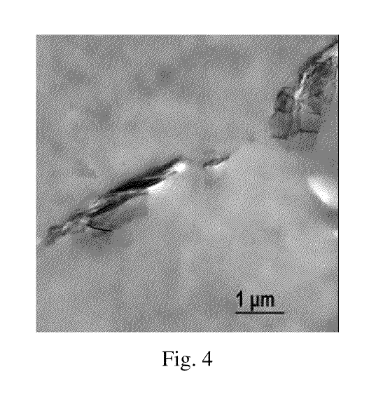

In FIG. 4, TEM of the 2 wt % graphite in the graphite PEA-C2C50% composite of Example 1B shows graphite dispersed therein.

XRD results for the graphite PEA-C2C50% composites of Examples 1A to 1C are shown in FIG. 5. The XRD results show a peak associated with intra-planar spacing of graphite at about 2-Theta of 26.5 degrees and demonstrate an extent of exfoliation of the UHSA exfoliated graphite and ABG 1045 graphite in the graphite PEA-C2C50% composites.

Conductivity of the graphite PEA-C2C50% composites of Examples 1A to 1C are shown in FIG. 6. FIG. 6 shows that conductivity remains approximately constant going successively from unfilled PEA-C2C50% of Comparative Example 1 to the 1 wt % graphite PEA-C2C50% composite of Example 1A and the 2 wt % graphite PEA-C2C50% composite of Example 1B, then increases about 10 times with the 5 wt % graphite in the graphite PEA-C2C50% composite of Example 1C. In FIG. 6, “1.0E-04,” for example, means 1 times 10 to the minus fourth power.

### Example 2A and 2B

Example 2A: composite of 1 wt % UHSA exfoliated graphite and PEA-C2C50% of Preparation 1C; Example 2B: composite of 2 wt % UHSA exfoliated graphite and PEA-C2C50% of Preparation 1C; and Example 2C: composite of 5 wt % UHSA exfoliated graphite and PEA-C2C50% of Preparation 1C

In an analogous manner, composites of 1 wt %, 2 wt %, and 5 wt % UHSA exfoliated graphite and PEA-C2C50% of Preparation 1C are respectively prepared according to the method of Examples 1A to 1C except UHSA exfoliated graphite is substituted for graphite. Samples of the composites of Examples 2A and 2C are characterized by TGA. The composites of Examples 2A to 2C are separately compression molded as described previously, and the resulting compression moldings characterized by melt viscosity (Example 2C only), dielectric constants (permittivities), loss factors, TEM (Example 2C only), XRD, and conductivity. The XRD results of FIG. 5 show absence of the peak at 2-Theta (20) of about 26.5 degrees, indicating a high degree of exfoliation of the UHSA exfoliated graphite in the composites of Examples 2A to 2C.

The TGA results are shown as parts of FIG. 7, which demonstrate that UHSA exfoliated graphite is dispersed in the composites of Examples 2A and 2C after compounding.

Dielectric constants (permittivities) and loss factors at 1000 Hertz and 100,000 Hertz are shown as parts of FIG. 8. FIG. 8 shows that dielectric constants (permittivities) and loss factors at 1000 Hertz typically increase slightly going successively from unfilled PEA-C2C50% of Comparative Example 1 to the 1 wt %, 2 wt %, and 5 wt % UHSA exfoliated graphite PEA-C2C50% composites of Example 2A to 2C. At 100,000 Hertz, dielectric constants (permittivities) and loss factors increase about 5 to 10 times from the 2 wt % to 5 wt % UHSA exfoliated graphite in the graphite PEA-C2C50% composites of Examples 2B and 2C.

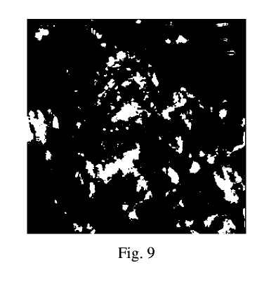

In FIG. 9, TEM of the 5 wt % UHSA exfoliated graphite in the graphite PEA-C2C50% composite of Example 2C shows UHSA exfoliated graphite dispersed therein.

As discussed above, the polymer carbon composite of the first embodiment has improved mechanical and conductive properties compared to a corresponding unfilled MSA material.

While the invention has been described above according to its preferred embodiments of the present invention and examples of steps and elements thereof, it may be modified within the spirit and scope of this disclosure. This application is therefore intended to cover any variations, uses, or adaptations of the instant invention using the general principles disclosed herein. Further, this application is intended to cover such departures from the present disclosure as come within the known or customary practice in the art to which this invention pertains and which fall within the limits of the following claims.

1. A polymer carbon composite comprising a molecularly self-assembling (MSA) material and a carbon filler dispersed in the MSA material, wherein the carbon filler is in the form of a particle having an average size of 30 micrometers (μm) or smaller, wherein the carbon filler comprises a graphite or expanded graphite, the carbon filler comprising from 1 weight percent (wt %) to 90 wt % of the polymer carbon composite based on total weight of the polymer carbon composite.

2. The polymer carbon composite as in claim 1, wherein the carbon filler comprises the expanded graphite.

3. The polymer carbon composite as in claim 2, wherein the expanded graphite comprises an ultra-high surface area (UHSA) expanded graphite.

4. The polymer carbon composite as in claim 1, wherein when the MSA material is in a form of a melt, the polymer carbon composite being characterized by a zero shear viscosity of less than 10,000,000 Pascal-seconds at from above Tₘ up to about 40° C. above Tₘ of the MSA material.

5. The polymer carbon composite as in claim 1, wherein the molecularly self-assembling material is a polyester-amide, polyether-amide, polyester-urethane, polyether-urethane, polyether-urea, polyester-urea, or a mixture thereof.

6. The polymer carbon composite as in claim 1, wherein the MSA material comprises self-assembling units comprising multiple hydrogen bonding arrays.

7.-9. (canceled)

10. The polymer carbon composite as in claim 1, wherein the molecularly self-assembling material comprises repeat units of formula I: 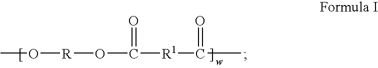
and at least one second repeat unit selected from the ester-amide units of Formula II and III: 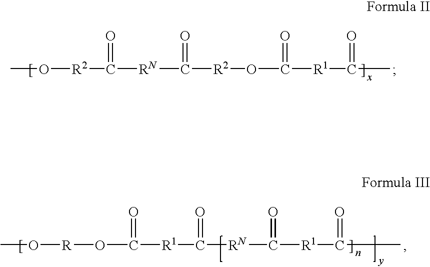
and the ester-urethane units of Formula IV: 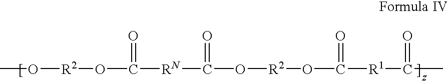
or combinations thereof wherein:
R is at each occurrence, independently a C₂-C₂₀ non-aromatic hydrocarbylene group, a C₂-C₂₀ non-aromatic heterohydrocarbylene group, or a polyalkylene oxide group having a group molecular weight of from about 100 grams per mole to about 5000 grams per mole;
R¹ at each occurrence independently is a bond or a C₁-C₂₀ non-aromatic hydrocarbylene group;
R² at each occurrence independently is a C₁-C₂₀ non-aromatic hydrocarbylene group;
R^{N} is —N(R³)—Ra—N(R³)—, where R³ at each occurrence independently is H or a C₁-C₆ alkylene and Ra is a C₂-C₂₀ non-aromatic hydrocarbylene group, or R^{N} is a C₂-C₂₀ heterocycloalkyl group containing the two nitrogen atoms, wherein each nitrogen atom is bonded to a carbonyl group according to formula (III) above;
n is at least 1 and has a mean value less than 2; and
w represents the ester mol fraction of Formula I, and x, y and z represent the amide or urethane mole fractions of Formulas II, III, and IV, respectively, where w+x+y+z=1, and 0<w<1, and at least one of x, y and z is greater than zero but less than 1.

11. The polymer carbon composite as in claim 1, wherein the MSA material is of Formula II or III: 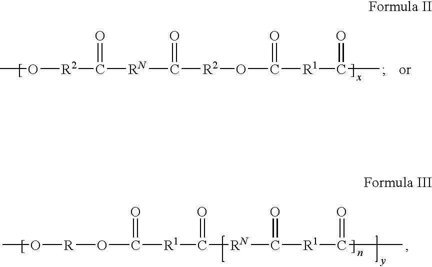
wherein:
R is at each occurrence, independently a C₂-C₂₀ non-aromatic hydrocarbylene group, a C₂-C₂₀ non-aromatic heterohydrocarbylene group, or a polyalkylene oxide group having a group molecular weight of from about 100 grams per mole to about 5000 grams per mole;
R¹ at each occurrence independently is a bond or a C₁-C₂₀ non-aromatic hydrocarbylene group;
R² at each occurrence independently is a C₁-C₂₀ non-aromatic hydrocarbylene group;
R^{N} is —N(R³)—Ra—N(R³)—, where R³ at each occurrence independently is H or a C₁-C₆ alkylene and Ra is a C₂-C₂₀ non-aromatic hydrocarbylene group, or R^{N} is a C₂-C₂₀ heterocycloalkyl group containing the two nitrogen atoms, wherein each nitrogen atom is bonded to a carbonyl group according to formula (III) above;
n is at least 1 and has a mean value less than 2; and
x and y represent mole fraction wherein x+y=1, and 0≦x≦1, and 0≦y≦1

12. The polymer carbon composite as in claim 1, wherein the number average molecular weight (Mn) of the molecularly self-assembling material is between about 1000 grams per mole and about 50,000 grams per mole.

13. The polymer carbon composite as in claim 1, wherein the MSA material itself (i.e., without carbon) is characterized by a melt viscosity of less than 100 pascal-seconds (Pa·sec.) at from above melting temperature (Tₘ) up to about 40 degrees Celsius (° C.) above Tₘ.

14.-17. (canceled)

18. The polymer carbon composite as in claim 1, wherein the MSA material itself is characterized by a melting temperature (Tₘ) greater than 60° C. or glass transition temperature (T_{g}) greater than −80° C.

19. (canceled)

20. A process for making a polymer carbon composite, the process comprising the step of: mixing a desired amount of a carbon filler in either a melt comprising the MSA material or a solution comprising a solvent and the MSA material to produce the polymer carbon composite as in claim 1.

21. An article comprising the polymer carbon composite as in claim 1.

22. The article as in claim 21, wherein the article comprises a molded part, coating, laminate, or electronic component.
